(19) United States
(12) Patent Application Publication
(10) Pub. No.: US 2007/0245971 A1
(43) Pub. Date: Oct. 25, 2007

(54) Bulk Produce Transport Container

(75) Inventor: Rodney Leslie Rayner, Ascot Vale (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Consolidated Marine Pty Ltd., Victoria (AU)

(21) Appl. No.: 11/718,888

(22) PCT Filed: Nov. 9, 2005
(86) PCT No.: PCT/AU05/01714

§ 371 Date: May 31, 2007

(30) Foreign Application Priority Data
Nov. 9, 2004 (AU) 2004906447

(51) Int. Cl. A01K 63/02

(52) U.S. Cl. 119/201; 119/227; 119/51.04

(57) ABSTRACT

A bulk produce transport container (10) including a tank (12) capable of supporting a wet environment, the tank having a storage region for storing produce and distribution conduits through which fluid passes into the storage region and through the produce; a refrigeration system for controlling temperature within the tank; and an assembly (11) through which fluid from the tank is capable of being recycled and filtered.

### BACKGROUND OF THE INVENTION

1. Field of the Invention

The present invention relates to arrangements for transporting live aquatic organisms. More particularly, the invention relates to a control module for maintaining the quality of a transport medium in a container. The control module preferably forms a filter system. The invention also extends to a system including a filter system in operative connection with one or more containers for transporting seafood. The present invention is particularly, although not exclusively, directed to a system for transporting live seafood by boat, rail or road transport from a production area to a market. The market may be local, interstate or international. Preferably, the filter system is reversibly engageable with one or more medium containers and is self-contained.

2. Description of the Prior Art

Reference to any prior art in this specification is not, and should not be taken as, an acknowledgment or any form of suggestion that this prior art forms part of the common general knowledge in any country.

Seafood is an extremely popular form of nutrient and source of high quality protein. In this specification, the expression “seafood” is to be understood as extending to both marine and freshwater species, particularly edible animal species intended for human consumption. Seafood is in demand virtually ubiquitously around the planet. However, this form of nutrition may be relatively expensive to acquire, particularly when produced through aquaculture activities. Seafood, once killed, also has a limited shelf life unless frozen. However, freezing is generally considered as damaging, at least to some degree, to the quality of the consumed product. Consequently, fresh seafood is more highly prized in the marketplace and commands a premium when available.

Various systems have been developed for transporting live seafood over substantial distances. Generally, however, as soon as any significant distance is involved, a considerable number of problems are encountered in maintaining environmental conditions suitable for survival and indeed healthy survival of the product. Once mortality commences in members of a population housed in a transport container, a high risk arises that the entire population will die or that the container load will be condemned as contaminated. Even if the consignment is not entirely lost, the quality of the container's contents may be downgraded in the marketplace with an associated decrease or even elimination of profits.

In order to reduce the risk of mortality, attempts have been made to minimise transit time. This usually results in the need to transport containers by air which, to date, has been essential in international trade. The producer/transporter pays high freight rates on loads that are predominantly made up of the weight of the container, filters, associated machinery and, most particularly, water. This inevitably inflates the final cost of the product and decreases competitiveness and appeal due to high overheads. The transporter is also left with the problem of returning the containers to the region of seafood production which further increases the running costs of the operation.

It would be of advantage if a system were provided that increased the survival time of seafood during transport. It would be of particular advantage if the survival time was increased sufficiently to allow transport of live seafood by sea, rail and/or road transport efficiently and with the use of existing and/or modified transport elements such as shipping containers.

At present, the fluid handling capacity of one container may be around 26,000 litres or the equivalent of 26 metric tonnes of weight. The cost of airfreight for this amount of water at a nominal cost of $3/kg would be in excess of $75,000. Marine freight costs tend to be around 5% to 10% of these costs depending on destination and efficiency of the marketplace.

### SUMMARY OF THE INVENTION

Throughout this specification, unless the context requires otherwise, the word “comprise”, or variations such as “comprises” or “comprising”, will be understood to imply the inclusion of a stated element or integer or group of elements or integers but not the exclusion of any other element or integer or group of elements or integers.

In one aspect, there is provided a bulk produce transport container including a tank capable of supporting a wet environment, the tank having a storage region for storing produce and distribution conduits through which fluid passes into the storage region and through the produce; a refrigeration system for controlling temperature within the tank; and an assembly through which fluid from the tank is capable of being recycled and filtered.

Preferably, the assembly includes a filtration device. The filtration device may include a biofiltration unit and/or an ozone sterilisation unit.

Preferably, the assembly includes piping for coupling an output of the filtration device to the distribution conduits. More preferably, the tank includes an outlet coupled to an input of the filtration device. Preferably, the tank is adapted to be flooded. Preferably, the tank includes a riser pipe coupled to the outlet, the riser pipe allowing fluid to exit the tank from a predetermined level, through the outlet.

Preferably, the tank includes rack structure for supporting the produce. Preferably, the distribution conduits are located beneath the rack structure. Preferably, the distribution conduits are coupled to rotatable distribution heads.

Preferably, the refrigeration system includes cooling elements which are located beneath the rack structure. Advantageously, this may result in it being possible to immerse the cooling elements in water, both when the tank is in a flooded condition (in which the water level may be above the rack structure) as well as in a non-flooded condition (in which the water level may be below the rack structure).

Preferably, the tank is in the form of a tanktainer provided with a food-safe lining. More preferably, the tank is in the form of a tanktainer with existing inlet and outlet ports arranged to couple with the filtration device.

Preferably, the produce is formed of aquatic organisms and the refrigeration unit is adapted to operate in two ranges, one of which is to maintain normal living temperature of the organisms and the other of which is to maintain the organisms substantially in a state of biostasis.

Preferably, the dimensions of the container are within the regulatory requirements for shipping containers. More preferably, the filtration device is further dimensioned to fit between the tank and the external dimensions of the container.

In accordance with another aspect, there is provided a filtration device adapted to couple to a tank of the container described above.

In accordance with yet another aspect, there is provided a transport tank including a filter system for maintaining an environment within the tank to sustain live aquatic organisms, the filter system comprising an outlet for channelling water from the tank; a filtration device in fluid communication with the outlet, the filtration device being adapted to filter water passing therethrough; a pump in fluid communication with the outlet and filtration device, the pump being adapted to circulate water through the filter system and back into the tank; and an inlet in fluid connection with the outlet, the filtration device and the pump and configured to return water to the tank.

Preferably, the filtration device includes a biofilter. Preferably, the filtration device includes an ozone unit for treating toxicity of water returned to the tank. More preferably, the ozone unit comprises a lamp, and a lamp filter for filtering output of the lamp. The tank may include a sensor for sensing a water property so as to control operation of the ozone unit. Preferably, the sensor is arranged to provide data on the water property for monitoring remotely of the tank. In one form, the sensor is a redox probe.

Preferably, the tank includes a refrigeration unit for cooling water in the tank to a temperature sufficiently low to maintain the organisms substantially in a state of biostasis. The temperature may be within the range of between 0 and −3 degrees Celsius.

Preferably, an inside surface of the tank has a coating suitable for safely containing freshwater and/or seawater.

Preferably, the tank is dimensioned according to the dimensions of standard 20′ shipping containers.

Preferably, the tank is arranged so as to have a flooded condition wherein the organisms are immersed in water, and a non-flooded condition in which the organisms are maintained above water level. Preferably, the tank has a temperature element within the tank for controlling temperature within the tank in both flooded and non-flooded conditions. The temperature element may be in the form of one or more rods.

Preferably, the tank is provided with a seafood support for supporting seafood above water level when the tank is in the non-flooded condition. More preferably, the support is located relative to the temperature element to enable the element to be immersed in the water in both flooded and non-flooded conditions.

Preferably, the tank is provided with a humidity control for controlling humidity within the tank. Preferably, the tank is provided with an oxygen control for controlling a level of oxygen within the tank.

The tank may be provided with a water outlet conduit having an opening located to regulate water level at the level of the opening.

In another aspect, there is provided a filter system for use with the transport tank described above, wherein the filter system is dimensioned to fit adjacent or at least near the tank such that the tank and filter system in combination are dimensioned within the dimensions of a standard 20′ shipping container.

A filter system for use with a seafood transport container comprises:
(i) one or more outlet pipes for channelling water from the container;
(ii) one or more filters in fluid communication with the one or more outlet pipes, the one or more filters adapted to filter water passing therethrough;
(iii) one or more pumps in fluid communication with the one or more outlet pipes and one or more filters, the pumps adapted to circulate water through the filter system and back into the container; and
(iv) one or more tank inlet pipes in fluid connection with the one or more outlet pipes, the one or more filters and the one or more pumps and configured to return water to the container;
   wherein the one or more filters comprise a plastic filter.

Preferably, the plastic filters comprise self-cleaning clutch disk-style filters. The filters are preferably adapted to filter particles of around ten micron diameter and larger. It is preferred that two separate disk arrangements are provided in the filter system. The disk type filters are as such in the compressed mode to allow for the filtration of particulate matter down to ten micron when sandwiched against each other. Due to the nature of the plastic they attract protein and other waste to the plates (a scum-like deposit). In the open wash mode, the plates are slightly separated and can be revolved from a secondary water/compressed air source to allow them to spin under pressure due to tangently applied jets, so as to rotate past the jet (120 psi) water air mix so facilitating cleaning. This equipment comprises of a number of commercially available parts but arranged with a different wash/operation system.

The filter system may include cleaning means for cleaning the filters. The cleaning means may comprise pressurised fluid supply means. The pressurised fluid supply means may provide pressurised liquid and/or gas supply. The gas may be air. The liquid supply may provide water. The water may be fresh. The cleaning means may include a cleaning pump to pressurise the fluid.

The filter system is preferably formed as a module or modular system for engagement with the container. The module may be formed with a frame supporting at least some of the components of the filter system.

The module may be adapted for mounting to an end of the transport container. Alternatively, the module may be adapted for mounting to a top or side of the container. The module is preferably formed with a length, a breadth and a width, wherein the width is substantially less than the other two dimensions thereby creating a low profile or wafer effect.

The transport container may be a single container such as a tanktainer. Alternatively, the container may comprise two or more discrete secondary containers. The secondary containers may be positioned inside a primary outer container.

The module is preferably reversibly and, most preferably, easily reversibly mounted to a container so that it may be removed for transport.

The filter system may further comprise secondary filter means. The secondary filter means may comprise one or more biofilters. Each biofilter may comprise one or more updraught column style enclosures. The enclosures may contain sintered glass and/or fine shell grit and may further incorporate skimmer means for removal of floating waste. Most preferably, five updraught column enclosures are provided although the number may be varied as required. The updraught columns may be configured to provide access at one or both of the top and bottom. The secondary filter means may be located on an optional loop of a flow pathway in the filter system. The optional loop may or a bypass loop or a combination of the optional loop and bypass loop may be chosen for flow of water from the container. The filter system may conveniently include air injection means for injecting air into the one or more biofilter columns.

The filter system may include skimmer waste removal means for removing floating waste from the biofilter columns. The skimmer waste removal means may comprise an air bleed arrangement designed to urge floating waste material outwardly from the filter columns.

The filter system may further incorporate cooling means for lowering the temperature of water circulated through the filter system. The cooling means may comprise a heat exchanger.

The filter system may further comprise heating means for increasing the temperature of water passing through the filter system. The filter means further conveniently comprises one or more heating elements. The heating elements may be titanium-sheathed elements. Most preferably, three independent titanium sheathed elements are provided in the filter system.

Conveniently, the filter system further comprises sterilising means for decreasing the microorganism population of the water passing through the filter system.

The sterilising means may comprise an ultraviolet sterilising arrangement. The ultraviolet sterilising arrangement may comprise or include a 254 nanometre germicidal low pressure tube positioned to irradiate container fluid flowing through the filter system. The low-pressure tube may have high a transparency granular quartz sleeve.

The pumping means may preferably comprise two separate independent pumps. The pumps may have a capacity of around 30,000 litres per hour.

The filter system may further comprise control means for controlling the function of the filter system. The control means may comprise programmable control means and preferably include a programmable logic controller. The programmable logic controller is preferably programmed to control pump speed, water flow and associated functions such as temperature control, wash cycles and also to detect abnormal and/or damaging conditions and provide alarm signs.

The filter system may further comprise power supply means. The power supply means may comprise inlet means for power from an external source such as mains power. Preferably or additionally, the power supply means includes a generator means for generating electrical current. The generator means may comprise a generator, preferably a diesel generator. The generator may provide around 15 kva.

The filter system preferably further also comprises water supply means. The water supply means may be fresh or salt water supply means for use in washing disks and other cleaning operations. This may include a storage tank and pump arrangement. The pump arrangement may include a pump for fluids and/or a compressed gas supply.

Preferably, the filter system incorporates and is supported on a frame. The frame may be formed from non-corrosive material such as aluminium, other suitable metal or polymeric materials. The frame may include fixing means for fixing to the container.

The wet surface areas of the filter system are preferably formed from a corrosion-resistant material. The corrosion-resistant material may be a plastics material such as polyvinyl chloride. Alternatively or additionally, the corrosive-resistant material may comprise a metal such as titanium.

A container may be provided with an attached filter system as described above.

A method of providing a transport container and filter system for live seafood comprises the step of positioning plastic filter members in a filter system flow path. Preferably, the method comprises fixing twin self-cleaning clutch disk-style filter arrangements in the flow path, wherein the twin filter systems are independent and selectable together and/or alternatively.

The method may further comprise providing automatic cleaning means for cleaning the filter arrangements, the automatic cleaning means adapted to deliver pressurised fluid such as water and/or gas. The gas may be air.

The method may further comprise the step of providing one or more biofilter columns for further filtering water flowing through the filter system. The method may further incorporate providing an air injection arrangement to provide pressurised air into the one or more biofilter columns.

The method may conveniently include providing a skimmer arrangement at the top of each biofilter column. The skimmer arrangement may include air bleed means for removal of foreign material. The method may further include the step of providing power to pump arrangements in the system. The method may further include heating and/or cooling water passing through the system and treating the water by antibacterial means such as an UV steriliser.

The method may include mounting the filter system on an end of a container. The container may comprise a single container element. Alternatively, a plurality of separate secondary containers may be provided which may be free standing or positioned inside a primary outer container. The method may further comprise forming the filter system as a relatively thin module. The method may further include adapting the filter system and secondary containers to stow inside the primary container for transport when not in operation.

A method for transporting live seafood comprises placing said live seafood in a seafood transport container comprising an attached filter system as hereinbefore defined and transporting said container to a destination. Preferably, transportation of the container is by any one or more of air, road, rail or sea.

### BRIEF DESCRIPTION OF THE DRAWINGS

In order to provide a better understanding of the present invention, preferred embodiments will be described in detail, by way of example only, with reference to the accompanying drawings in which:

FIG. 1 is a graphical representation showing a side schematic view of a first arrangement of a single tanktainer and filter system module;

FIG. 2 is a graphical representation showing a side schematic sectional view of a second arrangement, wherein the filter system is located inside a primary outer container which may be a 20′ container or 40′ container and a series of secondary containers are located internally;

FIG. 3 is a graphical representation showing a side schematic view similar to that of FIG. 2 but with the filter system module located externally on an end of the primary container;

FIG. 4 is a graphical representation showing a side schematic view similar to that of FIG. 2 but further comprising a power plant;

FIG. 5 is a graphical representation showing a side schematic view of a return mode packing with the filter system module and secondary containers packed along with additional transport, inside the outer container;

FIG. 6 is a graphical representation showing a side schematic view of a filter system in use with secondary containers on road transport;

FIG. 7 is a graphical representation showing a side view of a single tanktainer with a wafer-type single system mounted on its upper surface;

FIG. 7A is a graphical representation showing a top schematic view of the arrangement of FIG. 6 showing the distribution of the filter system module to provide access to an inspection opening;

FIG. 8 is a graphical representation showing a side schematic view of the modular arrangement of FIG. 7 when mounted to an outer primary container with secondary containers positioned therein;

FIG. 9 is a graphical representation showing a schematic view of one embodiment of a filter system of the present invention;

FIG. 10 is a diagrammatic sketch of a quartz lamp surrounded by media for oxidising ammonia and nitrite, showing one transverse cross-sectional view and one axial cross-sectional view;

FIG. 11 is a diagrammatic sketch of a system for oxidising ammonia and nitrite, showing one transverse cross-sectional view and one axial cross-sectional view;

FIG. 12 is a diagrammatic sketch of a tanktainer modified for transporting shellfish, showing an end view and a side view; and

FIG. 13 is another diagrammatic sketch of the modified tanktainer of FIG. 12, showing a cross-sectional top view, and a cross-sectional side view.

### DETAILED DESCRIPTION OF THE PREFERRED EMBODIMENTS

The present invention provides a considerable number of advantages which may include connecting fishermen, marine farmers and live suppliers to marketers through efficient use of existing container infrastructure and a novel filtering system to provide a cheaper system of a bulk salt water and freshwater transport. The present system can be used for both freshwater and salt water at tropical or cold climate settings. It is compact and can be manoeuvered by a forklift or hiablift arm. The filter system module is designed to work in conjunction with, for example, a marine 2260 20′ tanktainer of 10,000 litres to 26,000-litre volume. These tanktainers are usually made from food grade-type materials and used for bulk fluid handling. They form a large and efficient means of transporting bulk live product by road, sea and rail at a considerable cost saving compared to conventional air freight technique. In one embodiment, a unit of the present invention may also be used as a stand alone ancillary system to boost capacity of existing tank holding systems and may be adapted to be installed and operated efficiently and quickly due to flexible couplings and one-piece construction.

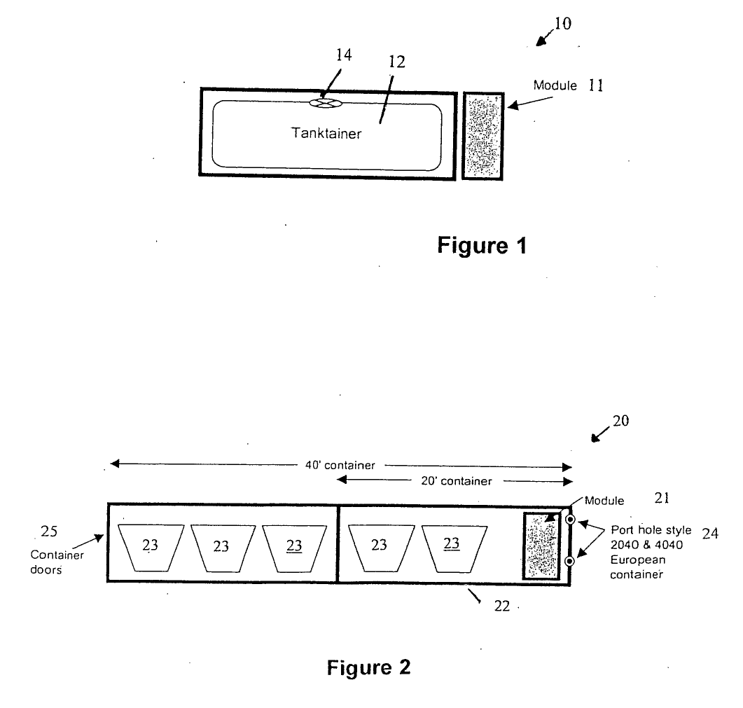

Referring to FIG. 1, there is seen a filter system and container arrangement 10 comprising a filter system module 11 and tanktainer 12. The tanktainer 12 is a single container, which is in fluid connection with the filter module 11. The filter module 11 may be driven by any suitable power source but is preferably provided with electric power and, most preferably, three-phase power. The tanktainer may be conveniently formed as an ISO 20′ (20 foot) tanktainer of 10000 litre to 26000-litre volume. A top access aperture 14 is provided to allow inspection and general maintenance of the tanktainer during operation.

The disk type filters are as such in the compressed mode to allow for the filtration of particulate matter down to ten micron when sandwiched against each other. Due to the nature of the plastic they attract protein and other waste to the plates (a scum-like deposit). In the open wash mode, the plates are slightly separated and can be revolved from a secondary water/compressed air source to allow them to spin under pressure due to tangently applied jets, so as to rotate past the jet (120 psi) water air mix so facilitating cleaning. This equipment comprises of a number of commercially available parts but arranged with a different wash/operation system.

One manufacturer supplies disks and spline. The spline was subsequently modified with a central control shaft. A new housing, control system and valving have been built to facilitate the necessary wash forces to clean it under conditions to adverse for the original design.

The adherent nature of waste marine filtrate under normal back wash conditions would keep the filter plates adhered together, clogging sooner than later, subsequently halting efficient flow of the filtrate; hence, the modifications to Spin Clean (trademark) design.

FIG. 2 shows a filter system and container arrangement 20 comprising a filter system module 21, an outer primary container 22 and a plurality of inner secondary containers 23. The outer primary container may be formed as a 20′ container or optionally a 40′ container. Portholes 24 are provided which may be 2040 and 4040 European-style non-integral reefers. Container doors 25 are provided.

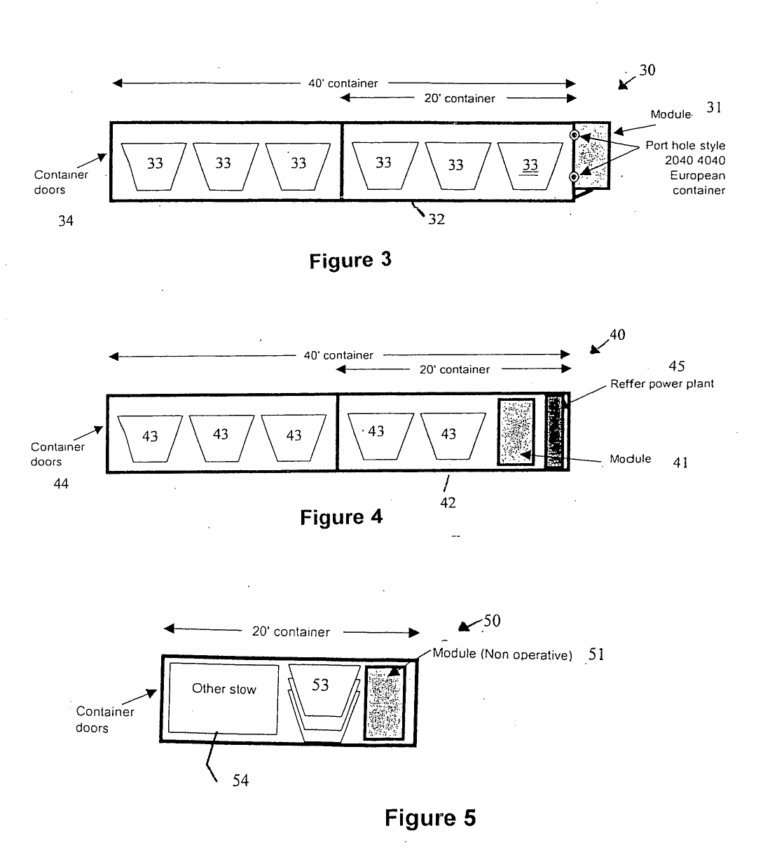

A further embodiment is shown in FIG. 3 where the filter system and container module 30 comprises a filter system module 31 and outer primary container 32. The outer container 32 may be a 20′ container or a 40′ container and houses secondary containers 33. The container has doors 34. The filter system module 31 is in fluid connection with the secondary containers 33 via porthole 35, which may be formed as styles 2040 or 4040. Inlet and outlet pipes (not shown) extend through these portholes into fluid engagement with the secondary containers.

The numbers 2040, 4040, 2232, 4232 and 2260 are container type identification numbers.

2040 or 4040:

The first two digits identify the length of the container—eg. 2020 means 20′ length container, and 4040 means 40′ length container. The third and fourth digits define the type of container—eg. 2040 means non-powered port hole type insulated container which cold air is pumped in and out of two holes (ports) to facilitate temperature control of contained product (externally controlled old European type).

2232 or 4232:

These containers are refrigerated containers of standard configuration containing the refrigeration module in one end (common refrigeration container). On supply to three phase power, and they will self-regulate the set point temperature.

2260:

It is a fluid handling container for bulk fluid. A tank in a 20′ container frame. 304 or 316L stainless steel construction in various volume sizing from 10,000 to 26,000 Its. These are generally insulated but not always.

FIG. 4 shows yet a further embodiment of a filter system module and container 40 with the module 41, primary container 42 and secondary containers 43. Container doors 44 are again provided. In this case, however, a power plant 45 is also provided to ensure the system is self-contained. The power plant may be any suitable type of generator, preferably exhausted externally and subject to automatic control to power up the filter system module 41 or, alternatively or additionally, batteries which supply power to the filter system module. The generator under certain configurations can be contained internally and exhausted through the container ports. For example, if in a European port hole 4040 type container, however, aboard ship this would not be the case due to the supply of ship's power, so it would be in off mode except under power fail conditions. In road or rail operations, it would be providing power to module so to take advantage of non-powered rates. Some of the rail services do not supply power as is the case with side loader container handling prime movers.

FIG. 5 shows one of the advantages of an easily demountable filter system module and container 50, wherein the module 51 is stored internally. Clearly, in the case of an embodiment such as FIG. 2, the module may be positioned easily in place. The secondary containers 53 have been stacked to decrease their volume and provide an effective means of transport back to the source. The cost of transfer may be defrayed by the addition of extra cargo 54, preferably paid cargo.

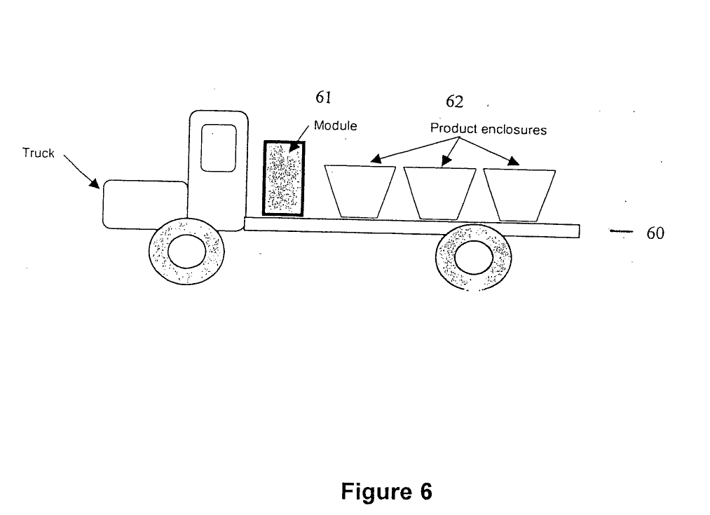

FIG. 6 shows a sideways schematic view of a truck 60 carrying a filter system module 61 in fluid communication with secondary enclosures or product enclosures 62. The present system allows for high quality control of the contents in the product enclosure 62 thereby increasing the survival rate and health of the contained species. The species may be any suitable species such as marine animals including abalone, oysters, fish, lobster or freshwater species such as fish, eels, redclaw shrimp or similar. These species are non-limiting and other species are within the scope and concept of the present invention.

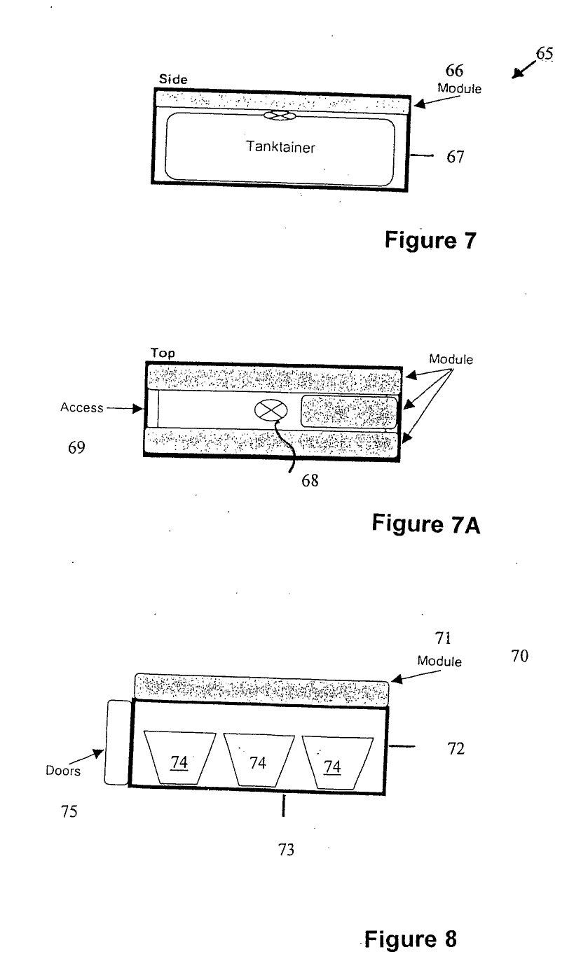

FIG. 7 shows a filter system and container combination 65, wherein the filter module 66 is formed as a thin arrangement located on the top of the container 67. This configuration may also be termed a “wafer” module. FIG. 7A is a top view, wherein the module extends around the access aperture 68. An end door 69 is also provided and the module is configured to surround the aperture while maintaining access.

FIG. 8 shows a further embodiment 70 of a module 71 and a container 72, wherein the container consists of a primary outer container 73 and fluid holding secondary container 74 located therein. Access is provided to the containers by doors 75. The module in this case is again a “wafer-type” construction, which has considerable advantages, described below.

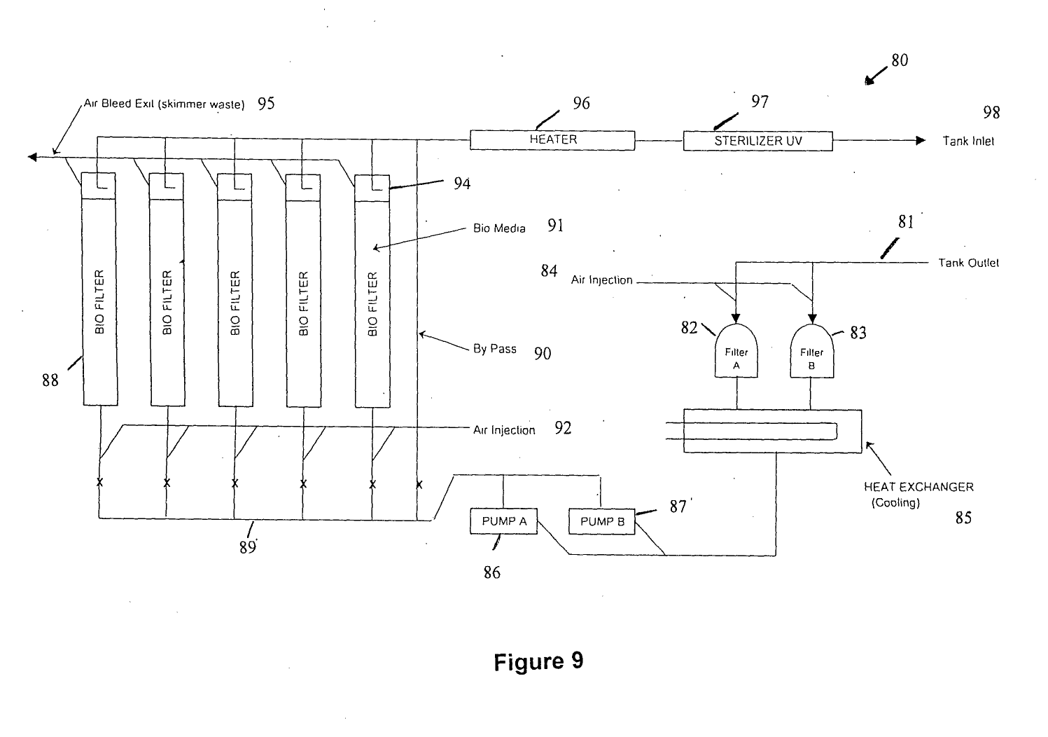

FIG. 9 shows a schematic outline of a filter system arrangement 80 comprising a tank outlet pipe or conduit 81. The tank outlet conduit may comprise two or more separate conduits or pipes. The pipes may be formed as flexible members. The pipes preferably have a dimension of around 50 mm for flexible hoses or 90 mm for bayonet hoses with cam lock connections at both ends. The tank outlets are in fluid communication with two filters 82, 83. The filters are preferably provided as plastic disk filters. They may conveniently be formed as twin self-cleaning clutch disk-style filters. They may be adapted to filter out particles of around 10 microns diameter or larger. Air injection lines 84 are provided to clean the filters. The air injection may drive a water reservoir source to pressurise the water and drive it onto the filter surfaces to thereby clean them. Alternatively, a pump might be provided for pressurising a water source which may be salt water or freshwater as convenient.

A cooling arrangement in the form of a heat exchanger 85 is provided for maintaining temperature at a desired level in hot conditions. This may particularly be a problem when a tanktainer is carried on the deck of a vessel in a tropical climate. Filtered water is then passed to one or both of two separate pumps 86, 87. It is preferred that redundancy is provided in case of problems arising with one of the pumps and also to spread the load. The pumps pressurise the filter system circuit and drive fluid through to biofilter columns 88 which are serviced by a manifold 89 which includes the option of a bypass line 90 should it be required. Flow to the biofilter columns 88 may be varied as appropriate. All water flow may be passed through them or, alternatively, water flow may be passed through the bypass or a combination of the two may be used to control the rate of filtering. Biomedia 91 is provided in the biofilter columns 88 and may comprise sintered glass and/or shell grit. Air injection means 92 is provided for driving air into the biofilters to provide oxygenation of the water and beneficial organisms located in the biofilter. Skimmer boxes 94 are positioned at the top of the biofilter columns 88 and arranged to remove flocculent or scum or foamy material through air bleed exit 95. Fluid is taken from the biofilters and passed through a heater 96 for use in colder climate and then through a steriliser 97 for return to a tank inlet pipe 98 which, again, may comprise one or more pipes. The pipes may be flexible or rigid. The pipes are designed to deliver back to one or more containers as required.

Various module configurations are shown in the drawings.
(i) Coupled to a tanktainer—ISO 20′, 10000 lt.˜26000 lt. (FIG. 1).
(ii) Internally in a 20′ or 40′ porthole insulated 2040˜4040 European style non-integral reefer (FIG. 2).
(iii) External on a 20′ or 40′ porthole insulated 2040˜4040 European style non-integral reefer (FIG. 3).
(iv) Internal in a 20′ or 40′ integral reefer container 2232˜4232—some reefer containers have vent points that can accommodate through connections of various cables—eg. Hoses (FIG. 4).
(v) Return mode (non-operative) in general dry container as LCL load including the supplementary product containment enclosures (FIG. 5).
(vi) Non-cell modes (static use) or on tray or van truck. Light vehicle transportation—tandem trailer or light truck for remote product experimentation background work (FIG. 6).

The embodiments of FIGS. 2, 3 and 4 require internal enclosures with tight fitting waterproof lids. In FIGS. 2, 3, 4 and 5, the system is over-stowable and fits standard slot requirements for use in high-density cellular vessels. Mode two and four are not over dimensional.

Water transport volume may be less efficient in a 20′ container (2232-2040) due to internal space restrictions, so that efficient use of 20′ cell slot may be satisfactory but can be improved with a single tanktainer. The available space in a 20′ conventional container limits the volume of water that can be carried internally due to the need for internal enclosures—all the space cannot be utilized. So the container would be shipped light, not at weight capacity; hence, a reduction in a carry product due to lower water volume being 25 tons maximum (road maximum gross). In the 40′ container with the increase in space but no weight increase (also 25 tons approximate) the maximum water volume can be comfortably included. Tanktainers are suited to maximum water carry capacity and can be sized according to maximum weight.

The 40′ container (4232-4040) allows the utilization of the full or close to 25 ton tri axle weight limit (road), but full 40′ slot and subsequent costs are incurred. This may prove more beneficial due to economies of scale.

The various modes are useful depending on what type of product is to be carried. Operator access may be required for individual enclosures for abalone examination—mortality of one abalone can affect or kill adjacent neighbouring abalone. Gill fish or scale fish, however, require maximum water and space and would be better suited to ISO tanktainer.

Side loader application is preferred for the 20′ and 40′ non-over dimensional module of FIGS. 2 and 4 for consolidation of product in remote locations where static holding system does not exist. There may be no hold up time for prime movers, seeing a number of fishing days may be required to constitute a shippable load.

One preferred embodiment may include the following features:
Frame: Aluminium C section 1.8 m×1.8 m×1.6 m
   Including four latching points for fluid or general container attachment
Filtration: Twin self cleaning clutch disk style
   Depth filters down to 10 micron
Pumps: 2 onga, 3Ø plastic boded 4 kw
   30,000 litres per hour (total flow=60,000 litres)
Bio filtration: 5 updraft column style enclosures
   Access—top and bottom (media type is optional)
   Generally sintered glass and fine shell grit incorporating skimmers.
Sterilization: By UV 254 nanometre germicidal low-pressure tube with high transparency granular quartz sleeve.
Heating: Three independent 3 kw titanium sheathed elements.
   400 v giving 9 kW total heating potential up to 35° C.
Cooling: Titanium immersion style heat exchanger.
   4 kW refrigeration plant handling temperature down to 10° C. based on ambient temperature of 38° C.
Control: Based on Omron PLC (programmable logic controller) overviews pump speed water flow by digital counter and all other functions including temperature and auto wash cycles.
   Abnormal conditions alarm function is triggered.
   Included are heavy shielding devices to run smoothly on rough generated power.
   This may provide for maximum operator ease of use.
Power: 3Ø phase
   400˜440 v standard with standard 32 amp plug (wired with no neutral for ship board power)
Water: Optional/fresh or salt water if supplied can facilitate no loss wash of conditioned tank water.
Generator: 15 KVA nominal.
Average load—approximately 8 KVA.
Heating requiring extra electrical load intermittently up to 14 KVA
Wet Surfaces: All contact water surfaces are PVC 316 L or titanium.

Standard shipping arrangement may provide satisfactory support. The following may be suitable:
(i) Deck slot with no over stow—access to inspection cover essential in tanktainer mode (product inspection);
(ii) Powered slot—standard reefer power supply;
(iii) The module makes the tanktainer over dimensional in the longitudinal axis. It is approximately 1.4 meters in excess length. A 40′ slot may suffice if the module does not extend past the end dimensions of the fluid container;
(iv) Water supplied by hose to tank by 10 mm (½″) hose—for back flush mode (can be run on conditioned tank water if required);
(v) An operator (system specialist) may be recruited to travel with the container from load to discharge destination (at present).

The tanktainer system may be used for both fresh and salt water at tropical or cold climate settings. The module is designed to work in conjunction with a marine 2260 20′ tanktainer of 10,000 litres to 26,000 litres.

The present system may provide automatic mechanical filtration down to approximately 10 micron particle size. This filtration system may be incorporated into the salt water circuit and positioned in front of the main pumps, so stopping the mixing of solid or semi-solid matter and allowing its subsequent removal.

The housing may be constructed from thick sections of plastic pipe machined to allow all openings and fittings to be located. Introduction of compressed air into the wash cycle may provide a far superior cleaning action than water alone.

The increased rate of speed tangentially across the filter plates coupled with extra turbulence appears to facilitate greater energy input and improve cleaning efficiencies when compressed air is used in cleaning. This may be achieved if the washing circuit is driven by compressed air only with fresh water (tap water or alternative salt water source) to be the washing agent.

There need be no washing pump at all in this configuration due to the compressed air being the driving force with and behind the fresh water washing cycle (wash circuit).

The washing volume of fresh water being driven by compressed air can be varied to suit washing needs, resulting in reductions of wash volume and cycle time. Water consumption as low as 3˜10 litres and wash times as short as 5 to 8 seconds are achievable. This is very short in comparison to conventional backwash actions, but with the spline able to stand differential pressures of 120 psi a short low volume high-pressure wash is very feasible and essential due to the high adhesion of the organic and particulate waste. Surprisingly, an advantage has been uncovered in pursuit of solving this cleaning problem. The ability of this filter to trap organic waste like a protein skimmer is a great advantage—it appears to behave in this fashion due to the solid liquid interface, perhaps similar to a protein simmer which uses a liquid gas interface. Once high-pressure organic waste removal from the plates is achieved due to a high turbulence wash, a secondary cleaning action may become feasible. Efficiencies beyond 10 micron depth screening application are envisaged.

A larger filter area and a lower pressure differential can maximise this effect across the filter face by utilising a longer spline and higher plate pressures (compressive forces) supplied by a different actuation mechanism below the main manifold pipe.

The number of plates can be increased so giving greater throughput in a similar externally sized filter by extending the filter housing cover. Thus a 30-40% efficiency gain is obtained by a similar filter area increase; pressure differential is reduced, thus increasing energy savings. A subsequent spin off may be greater retention of organic material to the filter disks due to lower flow speeds. The lower pressure differential may reduce heat transfer at the filter head so reducing refrigeration and pumping costs.

Valves for inlet and waste may be bronze offset branch V type, tin plated and then electrostatically coated. They may be of dual-action type due to vacuum pressure necessities of the filtration/wash modes. Actuation mechanisms and hydraulics are all plastic with 24 v AC solenoid activations. “Wilden” (trademark) (diagram) supply pump is for hydraulic control as is the “Onga” (trademark) pressure reservoir, modifications being larger control tube size and the prime hydraulic fluid being fresh water drawn from the wash supply, eliminating control corrosion and gumming problems.

Tighter control action of the valves has been achieved due to the nature of the operation cycle, removal of salt water by vacuum and air pressure, compressed air water wash, subsequent expulsion of the fresh water followed by refill with salt water thus enabling retention of particulate organic matter in the housing facilitating its removal from the filter enclosure. Three solenoid control circuits for every filter head may be beneficial and control of these by a more sophisticated logic controller may be appropriate.

Twin all plastic three-phase “Onga” pumps are suitable and may be coupled with variable three-phase speed control have allowed efficient running at times of low product load or operation of less than the capacity tanking volume. Installation of the pumps is as low as possible, in this case at the approximate base of the fluid level. Pump protection circuitry and thermal overload may be controlled by the same master logic controller.

A “Manarope” (trademark) compressor, condenser, fan unit has proved suitable. Heat removal on board ship and in transit can easily be addressed by circulating exchange fans.

The heat exchanger may be titanium tube bent and rolled to suit the compact manifold. By utilising the coil and straight length chiller assembly in the manifold section of the module, the advantage of high water turbulence is exploited obtaining the highest thermal exchange.

Skimmers provide the highest efficiencies when the contact path between the water and air is the greatest possible length. One option is to run the skimmer under partial pressure. On the suction side of the main pumps air is bled into the water flow for aeration purposes increasing dissolve oxygen levels and is subsequently removed on the topside of the five updraft bio-filters. The secondary air injected into the water at the bottom of the updraft enclosures creates a void at the top of the cylindrical enclosures allowing the excess air and polluted foam to be drawn off with a secondary exit bleed system. The combination of the bio-filters and the skimmer is space saving and novel due to the dual action of the one series of enclosures. Both for bacterial filtration and protein/waste removal, there is a saving of design space and weight which is important in some transport formats. In this format the entire system may operate as a skimmer as well as aiding in gas exchange and increasing water oxygen content.

In the conventional system layout the biofilter is part of the complete overall circuit, usually the first component post overflow from the tank. The filter is placed there to take advantage of the (possible) slight rise in temperature due to the fact of being the last component before the chillier. There are however numerous disadvantages with this arrangement which may include:
(i) Lack of dissolved oxygen at the tank outfall.
(ii) A large amount of dissolved and particulate organic and other matter lodging in the upper layers of the filter making it prone to clogging, increasing pollution levels.
(iii) No possibility of increased aeration, without some form of mechanical injection or infusion.
(iv) The filter is very difficult to separate from the main biological environment.
(v) No way to stop the high biological demand of carrying product removing the vast majority of oxygen at the expense of the bacterial colony reducing efficiency.
(vi) No possibility of using any variation of pressure, oxygen or heat to aid the bacterial enzymatic waste breakdown processes.

In the present invention, the biofilter may be run on a separate ancillary loop, monitored for flow. Build up of ammonia, nitrite and nitrate are slow processes in a low micron mechanically filtered skimmed tanking system. The entire tank volume is to be cycled through the filter at a different rate of flow. The resultant isolation of the filter enables ‘custom’ variation of the environment (dissolved oxygen) to suit bacterial growth. Optimum growth conditions for bacteria vary from that of the carry product. First is temperature, second is ammonia, other protein decomposition products considered sustenance to filter bacteria which can be deadly to the tanked product. The need for partial operational autonomy may arise. Apart from substrate mediums that have higher specific surface areas, the key factor increases in bioactivity are temperature, pressure and oxygen. These variations have been addressed in the present invention to a large extent allowing greater operating efficiencies.

UV serialisation may be utilised on two fronts. The first is to treat incoming seawater exchange on board vessel, if required as the biological purity of the water cannot be established. This may be precautionary against contamination. The second is the maintenance of bio-filter colony and may or may not be utilised dependent on the type and state of bio-filter development, product type and load. In the third instance, it may reduce harmful pathogens in the salt water environment or as a legislative requirement for some shellfish.

These systems vary from the normal layout of a conventional tanking system in many fundamental ways.

One deviation from the norm is automatic mechanical filtration down to approximately 10 micron particle size. This filtration system is incorporated into the primary loop circuit and is positioned in front of the main pump, so stopping the mixing of solid or semi-solid matter and its subsequent removal.

The disk compression filters may have the added advantage of behaving in a manner similar to a protein skimmer utilising the solid liquid interface similar to the liquid gas interface of a foam fractionator (a foam fractionator being only effective in salt water).

The filters are monitored electronically and are washed according to load by fresh water driven with compressed air (wash volumes of as little as 8 litres are the norm). No conditioned tank water is lost in this process and total removal of particulate and organic waste is achieved.

This technology has allowed the compression of the biofilter into a transportable size without reducing its capacity of ammonia reduction.

The pumping system is duplicated for reliability incorporating speed control for power conservation at low product loads (consolidation of load or market discharge of product). The reduction of water speed also leads to savings in refrigeration costs due to reduced friction.

Non-biological Reduction Of Ammonia

The reduction of ammonia is conventionally dealt with by bio filtration—a suitable colony of bacteria housed and fed in the appropriate manner. In many cases, this can be a source of problems relating to varying load and other bio-factors.

The use of ozone and UV radiation together in an ozone unit can oxidise the two toxic substances “ammonia and nitrite” to the less harmful nitrate. The reactions mimic bacteriological oxidization.

Outline of an example: Ozone produced optically 180-290 n/m band UV or via electrical discharge (corona) is fed into a contract chamber where it is exposed to UV mercury argon discharge lamps. Broad band radiation 180-260 n/m (ultraviolet) is used the longer wave lengths creating ozone, the shorter wave length decomposing ozone, variation of the wave lengths may produce increased performance by reducing the decomposition band, and secondarily targeting specific chemicals in solution—increasing their energy potential; hence their ability to be oxidised.

The variation in the UV field may be achieved by transmission through another media, gas or liquid surrounding the lamp, so absorbing specific bands and letting the preferred radiation pass into the reaction chamber. The filtration (UV absorbing) solution/gas can be many and varied according to the species to be oxidised or bands to be absorbed.

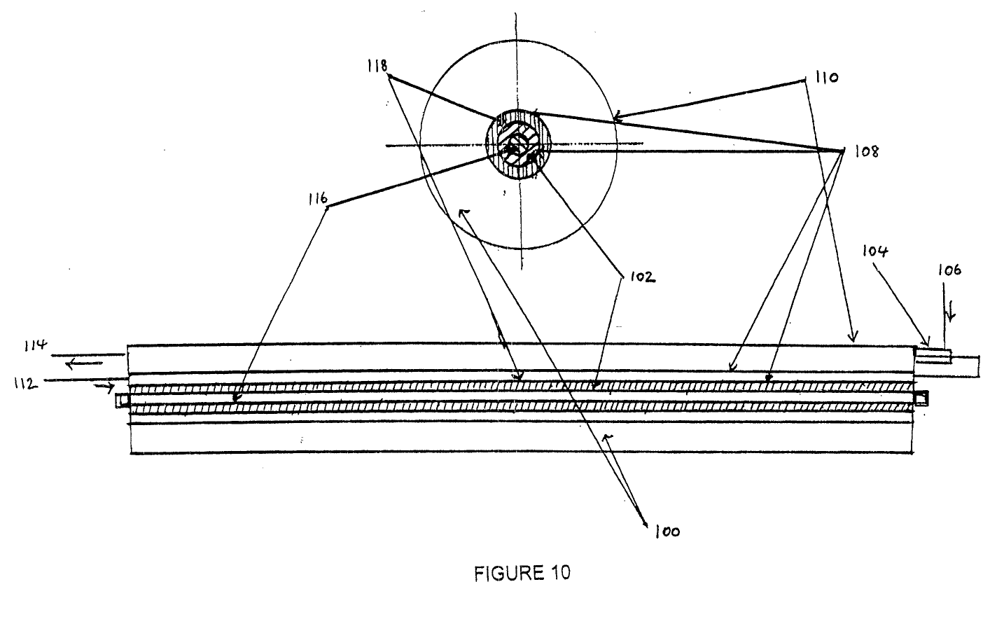

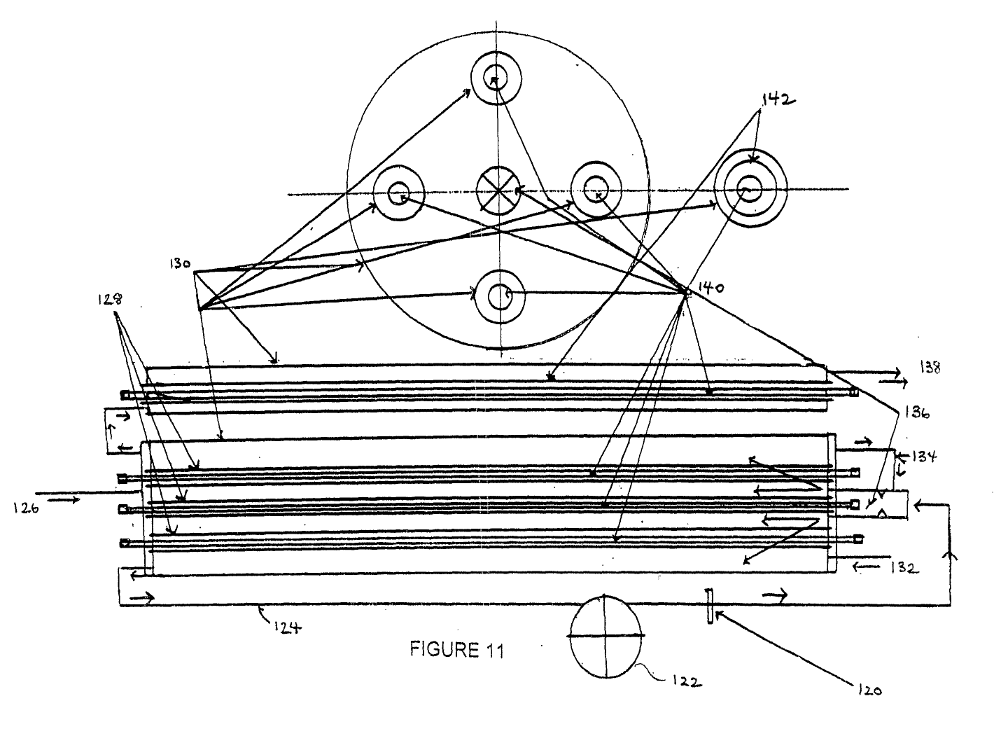

Traditional treatment of quartz glass with radiation absorbing substances—e.i. Vicor™ is only aimed at stopping the production of ozone by eliminating the 180-200 n/m UV range, passing the shorter wave length “germicidal” 254 n/m decomposition band. This can be overcome by surrounding the quartz lamp by a given media (see FIGS. 10 and 11).

Control of the ozonisation process is achieved by millivolt readings taken in the contact/irradiation chamber by a platinum redox probe coupled to a electronic circuit that can be set at a particular millivolt setting, so allowing the flow of polluted water (ie. redox “millivolt” falls below target range flow slows or stops until millivolt range recovers; thus allowing the right exposure contact time for various oxidisable pollutants).

The resulting time versus millivolt curve signatures can be used to calculate the amounts and types of pollutants present in any given sample of water—or total oxidisables. The relationship between the starting millivolt range, the plotted curve against time will give signatures of what substances are being oxidised and their levels; so the contact chamber can be used as an analytical instrument with the appropriate computer interface.

The speed of the rise in the millivolt reading can be used to determine the total load on the water treatment system, so allowing the reduction of energy if the m/volt rise is quick (clean water), so the reaction chamber can be throttled back to conserve energy if not required.

Batch like transfer through the contact chamber allows continual analysis of water condition and machine performance.

Note that no effective on-line method of ammonia or nitrite sensing is available at this time. Redox is a general oxidization potential reading which can be high or low, masking harmful ammonia or nitrite—only when these substances are under oxidative attack can we determine their volume and nature. The use of durable redox probes in this manner produces an instrument of durability and accuracy. Calibration of any contact chamber with known standards (pollutants) can easily be achieved and the instrument/machine set to the required level of performance.

This system can stand alone or support a conventional bio-filter to overcome shock loading or poor performance for any number of reasons. The combination of bio-filtration will allow denitrification (nitrate removal) or as the bio-filter conditions the energy demand for the oxidation/contact chamber can be wound back making use of the more economical (energy wise) bio-colonies.

The use is not only confined to ammonia and nitrite but to other man made pollutants—ie. herbicides and insecticide pollutants, organometal halides which prove almost impossible to break down by conventional water treatment technologies. These can be oxidised by this novel technique.

The irradiation of the ozone may create other oxidising species of greater oxidising potential than ozone O³. The passive background radiation may also increase the energy levels in target species making them more susceptible to oxidative reactions.

The exit of treated water is via a second chamber where it is exposed to narrow band 254 n/m UV. This decomposes the ozone present in the exit stream, so alleviating any downstream damage to bio-colonies or product in the holding system.

The parts identified in FIGS. 10 and 11 are as follows:
100 Water ozone UV contact chamber
102 Media gap UV filter
104 Venturi injector
106 Inlet water
108 Broad band sleeves
110 External enclosure
112 Inlet air path
114 Exit water
116 Mercury Argon Broad band lamp
118 Air/Dry air/Oxygen intensified air/Oxygen
120 Redox probe
122 Circulating pump
124 Circulating water loop
126 Air inlet
128 Sleeve (quartz wide band)
130 External enclosure
132 Inlet water
134 Ozone path
136 Venturi injector
138 Exit water
140 Mercury Argon UV lamps
142 Sleeve (Vicor™)—narrow band
   Atmosphere Controlled Tanktainers

The use of tanktainers for the transport of shellfish (i.e. mussels, oysters and cackles) can be streamlined by running a section of the transport leg in a moist damp non-flooded atmosphere controlled state.

Road regulations for fluid tank handling when full or partially full of liquid are very restrictive, with no over weight permits and the use of side-loaders prohibited due to them not being of a low profile nature. This eliminates point delivery/pickup.

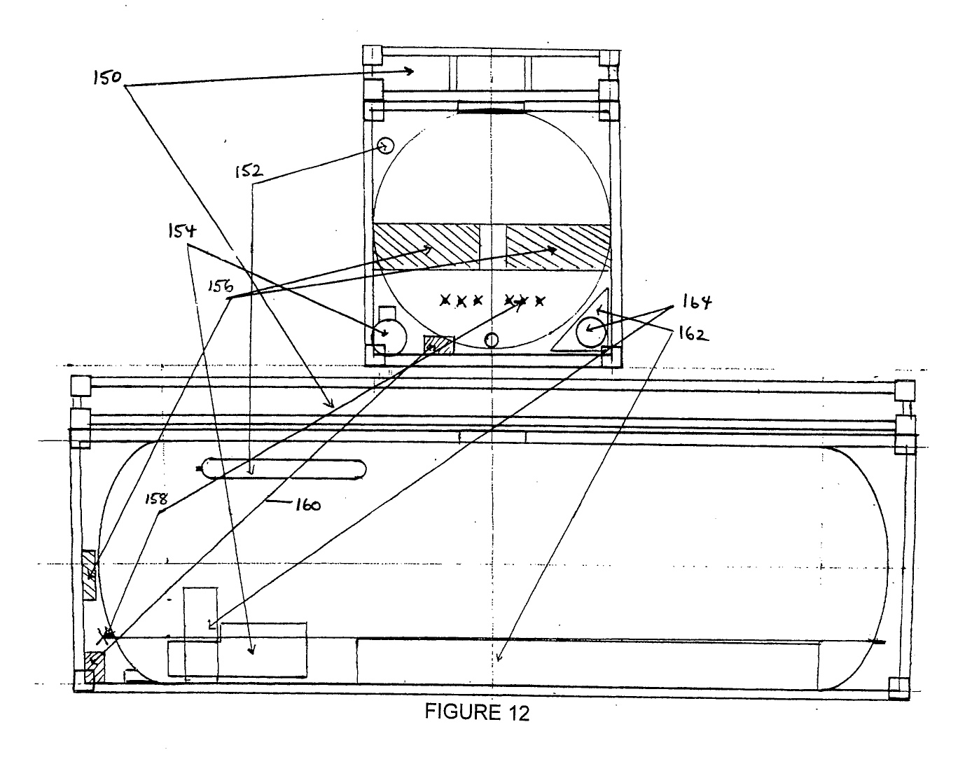

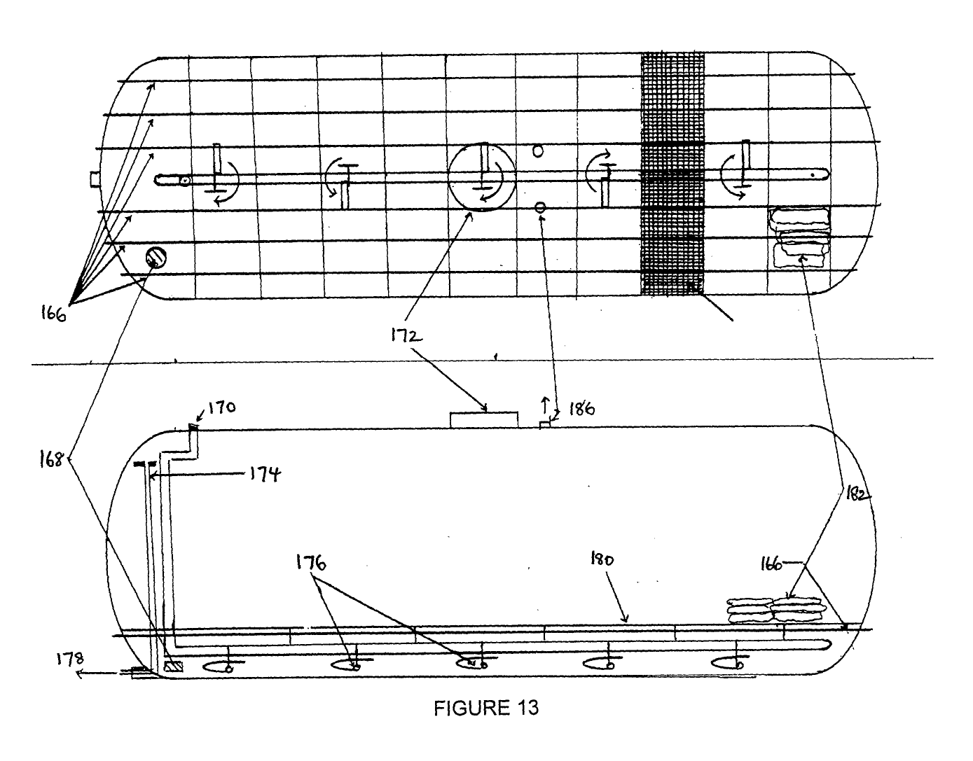

The atmosphere consists of an oxygen rich water saturated due point atmosphere—ie. “cool fog like environment” allowing the shellfish to breath when required. Temperature is regulated by titanium tubes towards the bottom of the tanktainer allowing cooling in both full (flooded) and empty (non-flooded) modes (wet or dry). Extensive modifications to an existing tanktainer are outlined in FIGS. 12 and 13.

The tank can be flooded at a pre-trip location or on board the vessel at the start of the marine section of the transport leg. Subsequently emptied at the point of discharge, so allowing road loads to be under the legislative requirements on both road ends of the transport journey.

The option to hold the tank in the flooded mode can allow it to hold product for a considerable period of time—many weeks if necessary to allow successful marketing of a premium product without the nagging effects of shelf life. The use of 17,500 It tank allows for both dry and wet weight requirements.

Although the temperature may usually be controlled at an optimum “living” temperature for storing the produce, if an event is experienced which is capable of jeopardising the conditions within the tank (for example a system failure), the temperature may be sensed by a sensor and reduced automatically to around −2 to −3 degrees Celsius (for example) to maintain the produce substantially in a state of biostasis to assist in its preservation. The use of power freezing during system failure for whatever reason is also assured due to the product being immersed in sea water allowing fast and efficient brine freezing, retaining product saleability at the worst case scenario.

Remote satellite monitoring of these systems can be readily achieved allowing the operator to make remote decisions on the cargo condition due to a number of factors.
Optical images
Oxygen demand
PH control dosing—carbon dioxide levels
Machine operation status
Flow
Pressure
Temperature
Power status

Atmosphere humidity is provided by an ultrasonic transducer at water level (below floor) to create a fog like mist. Oxygen is provided by an external cylinder via regulator to the internal atmosphere. Slow bleed through the tank can be maintained so exchanging atmosphere as required—set rate of entry and set rate of exit.

Note that the tanktainer can operate separately from the water processing module, standing alone.

There are two other modes of transport use not related to live transport are outlined below. They are novel uses of the refrigerated system and do not require the water treatment module.

The use of liquid ice Slurry to transport difficult to carry product in the tanktainer to overseas destinations—“Refrigerated Mode”. The use of liquid ice gelatine slurry to transport difficult to transport product to overseas destinations—“Refrigerated Mode”.

The parts identified in FIGS. 12 and 13 are as follows:

150 Clip-on top load water conditioning module
152 Oxygen cylinder
154 Generator 20 KVA
156 Refrigeration condensers
158 TX valves
160 Dual standard power transformer & leads/plugs shore/ship power
162 Fuel tank (diesel)
164 Refrigeration compressor
166 Cooling tubes
168 Ultrasonic vapour system
170 Supply (inbound salt water)
172 Man hole
174 Floating top level skimmer (outbound salt water)
176 Revolving distribution heads (inbound salt water)
178 Outbound salt water
180 Floor (mesh holed)
182 Product stacked in 15 kg polypropylene mesh bags (open weave)
184 Floor panels (same over entire area)
186 Outbound salt water (full mode)

Throughout the specification, the aim has been to describe the preferred embodiments of the invention without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the disclosure.

1. A bulk produce transport container for transporting live aquatic organisms, the transport container including:
(iv) a tank capable of supporting a flooded environment, the tank having a storage region for storing the organisms and distribution conduits through which fluid passes into the storage region and past the organisms;
(v) a refrigeration system for controlling temperature within the tank;
(vi) an assembly through which fluid from the tank is capable of being recycled and filtered; and
(vii) a humidity controller for controlling humidity within the tank;
whereby the container has a flooded mode in which a flooded environment is maintained within the storage region to sustain the live aquatic organisms immersed in fluid, and a non-flooded mode in which a non-flooded environment with humidity controlled by the humidity controller is maintained within the storage region to sustain the live aquatic organisms in a state enabling them to breathe above fluid level.

2. A container as claimed in claim 1, wherein the assembly includes an ultraviolet source and an ozone supply for reducing a level of an oxidisable pollutant in the fluid by using ultraviolet radiation from the ultraviolet source in combination with presence of ozone from the ozone supply.

3. A container as claimed in claim 1, wherein the assembly includes piping for coupling a filtration device, and the distribution conduits are in fluid communication with the piping so as to feed recycled fluid from the filtration device to the tank for maintaining a fluid level in the flooded mode.

4. A container as claimed in claim 3, wherein the filtration device includes an ozone sterilisation unit.

5. A container as claimed in claim 3, including a support for supporting the organisms below the fluid level in the flooded mode, and above the fluid level in the non-flooded mode.

6. A container as claimed in claim 5, wherein the support is in the form of a rack structure, and the refrigeration system includes cooling elements which are located beneath the rack structure.

7. A container as claimed in claim 5, wherein the distribution conduits feed fluid to the tank through one or more nozzles located below the fluid level in both flooded and non-flooded modes.

8. A container as claimed in claim 7, wherein the or each nozzle is in the form of a rotatable distribution head.

9. A container as claimed in claim 1, wherein the humidity controller includes a vapour system for providing humidity within the tank in the non-flooded mode.

10. A container as claimed in claim 9, wherein the vapour system is an ultrasonic transducer located at or near the fluid level in the non-flooded mode.

11. A container as claimed in of claim 3, wherein the tank includes a riser pipe coupled to an outlet of the tank, the riser pipe allowing fluid to exit the tank from a predetermined level, through the outlet, so as to regulate the fluid level in the flooded mode.

12. A container as claimed in claim 11, wherein the outlet of the tank is in fluid communication with outlet piping for coupling to the filtration device.

13. A container as claimed in claim 3, wherein the filtration device forms part of the assembly.

14. A container as claimed in claim 3, wherein the filtration device is a separate unit arranged to couple to the piping.

15. A container as claimed in claim 13, wherein the filtration device includes a biofiltration unit.

16. A container as claimed in of claim 1, wherein the tank is in the form of a tanktainer provided with a food-safe lining.

17. A container as claimed in claim 16, wherein the tank is in the form of a tanktainer with existing inlet and outlet ports arranged to couple with the filtration device.

18. A container as claimed in claim 1, including a control system for detecting an event capable of adversely affecting the environment within the tank, and for controlling the refrigeration system to reduce the temperature within the tank from a normal level to a sustained lower temperature level to assist preservation of the produce.

19. A container as claimed in of claim 1, wherein the refrigeration unit is adapted to operate in two ranges, one of which is to maintain normal living temperature of the organisms and the other of which is to maintain a lower temperature at which the organisms are substantially in a state of biostasis.

20. A container as claimed in claim 3, wherein the external dimensions of the container are within the regulatory requirements for shipping containers.

21. A container as claimed in claim 20, wherein the filtration device is further dimensioned to fit between the tank and the external dimensions of the container.

22. A filtration device adapted to couple to a tank of the container claimed in claim 1.

23. A transport tank including a filter system for maintaining an environment within the tank to sustain live aquatic organisms, the filter system comprising:
(v) an outlet for channelling water from the tank;
(vi) a filtration device in fluid communication with the outlet, the filtration device being adapted to filter water passing therethrough;
(vii) a pump in fluid communication with the outlet and filtration device, the pump being adapted to circulate water through the filter system and back into the tank; and
(viii) an inlet in fluid communication with the outlet, the filtration device and the pump and configured to return water to the tank,
whereby the tank has a flooded mode in which a flooded environment is maintained within the tank to sustain the live aquatic organisms immersed in water, and a non-flooded mode in which a non-flooded environment with humidity controlled by a humidity controller is maintained within the tank to sustain the live aquatic organisms in a state enabling them to breathe above water level.

24. A tank as claimed in claim 23, wherein distribution conduits are in fluid communication with the inlet so as to feed filtered water from the filtration device to the tank or maintaining a water level in the flooded mode.

25. A tank as claimed in claim 24, wherein the distribution conduits feed water to the tank through one or more nozzles located below the water level in both flooded and non-flooded modes.

26. A tank as claimed in claim 25, wherein the or each nozzle is in the form of a rotatable distribution head.

27. A tank as claimed in of claim 23, including a support for supporting the organisms below the water level in the flooded mode, and above the water level in the non-flooded mode.

28. A tank as claimed in claim 23, wherein the humidity controller includes a vapour system for providing humidity within the tank in the non-flooded mode.

29. A tank as claimed in claim 28, wherein the vapour system is an ultrasonic transducer located at or near the water level in the non-flooded mode.

30. A tank as claimed in claim 23, including a riser pipe coupled to the outlet, the riser pipe allowing water to exit the tank from a predetermined level, through the outlet, so as to regulate the water level in the flooded mode.

31. A tank as claimed in of claim 23, wherein the filtration device includes a biofilter.

32. A tank as claimed in anyone of claim 23, wherein the filter system includes an ozone unit for treating toxicity of water returned to the tank.

33. A tank as claimed in claim 32, wherein the ozone unit comprises a lamp, and a lamp filter for filtering output of the lamp.

34. A tank as claimed in claim 32, wherein the tank includes a sensor for sensing a water property so as to control operation of the ozone unit.

35. A tank as claimed in claim 34, wherein the sensor is arranged to provide data on the water property for monitoring remotely of the tank.

36. A tank as claimed in claim 34, wherein the sensor is a redox probe.

37. A tank as claimed in claim 27, wherein the tank includes a refrigeration system for cooling water in the tank to a temperature sufficiently low to maintain the organisms substantially in a state of biostasis.

38. A tank as claimed in claim 37, wherein the support is in the form of a rack structure, and the refrigeration system has cooling elements located beneath the rack structure.

39. A tank as claimed in claim 37, wherein said temperature is within the range of between 0 and −3 degrees Celsius.

40. A tank as claimed in claim 23, wherein an inside surface of the tank has a coating suitable for safely containing freshwater and/or seawater.

41. A tank as claimed in claim 23, wherein the tank is dimensioned according to the dimensions of standard 20′ shipping containers.

42. A tank as claimed in claim 23, wherein the tank is provided with an oxygen control for controlling a level of oxygen within the tank.

43. A filter system for use with a transport tank as claimed in claim 23, wherein the filter system is dimensioned to fit adjacent or at least near the tank such that the tank and filter system in combination are dimensioned within the dimensions of a standard 20′ shipping container.

44. A method of storing live aquatic organisms, including the steps of:
(i) containing the live aquatic organisms in a tank of a transport container;
(ii) controlling humidity within the tank with a humidity controller;
(iii) selectively operating the container in a flooded mode in which a flooded environment is maintained within the tank to sustain the live aquatic organisms immersed in water; and
(iv) selectively operating the container in a non-flooded mode in which a non-flooded environment with humidity controlled by the humidity controller is maintained within the tank to sustain the live aquatic organisms in a state enabling them to breathe above water level.

45. A method of storing live aquatic organisms, including the steps of:
(i) containing the live aquatic organisms in a tank;
(ii) filtering water from the tank through a filter assembly;
(iii) recycling water filtered through the filter assembly to the tank;
(iv) selectively operating the tank in a flooded mode in which a flooded environment is maintained within the tank to sustain the live aquatic organisms immersed in water; and
(v) selectively operating the tank in a non-flooded mode in which a non-flooded environment with controlled humidity is maintained within the tank to sustain the live aquatic organisms in a state enabling them to breathe above water level,
wherein water from the tank is continuously recycled and filtered through the filter assembly in both the flooded mode and the non-flooded mode.

46. A filtration system for live aquatic organisms, including:
(iii) a tank capable of supporting a flooded environment, the tank having a storage region for storing the organisms and distribution conduits through which fluid passes into the storage region and past the organisms; and
(iv) an assembly through which fluid from the tank is capable of being recycled and filtered;
whereby the filtration system has a flooded mode in which a flooded environment is maintained within the storage region to sustain the live aquatic organisms immersed in fluid, and a non-flooded mode in which a non-flooded environment with controlled humidity is maintained within the store region to sustain the live aquatic organisms in a state enabling them to breathe above fluid level, wherein the assembly as adapted for continuous recycling and filtration of fluid from the storage region in both the flooded mode and the non-flooded mode.

47. A method of storing live aquatic organisms, including the steps of:
(i) containing the live aquatic organisms in water in a tank;
(ii) filtering water from the tank through a filter; and
(iii) returning the filtered water to the tank;
wherein the step of filtering the water includes the step of using ultraviolet radiation in combination with presence of ozone so as to reduce a level of an oxidisable pollutant in the water.

48. A method as claimed in claim 47, wherein the oxidisable pollutant is ammonia.

49. A method as claimed in claim 47, further including the step of injecting the ozone into a chamber of the filter which is also subject to the ultraviolet radiation, and controlling rate of flow of water through the chamber so as to maintain a redox rating of the water.

50. A method as claimed in claim 48, further including the step of providing the ultraviolet radiation at a frequency level(s) such that energy from the ultraviolet radiation is absorbed by the ammonia, and such that the ozone is decomposed so as to provide an environment in the filter capable of oxidising the ammonia to nitrate.

51. A method as claimed in of claim 47, wherein the ultraviolet radiation is provided at a first frequency level for forming ozone from oxygen.

52. A method as claimed in claim 51, wherein the ultraviolet radiation is provided at a second frequency level for decomposing the ozone to oxygen.

53. A method as claimed in claim 52, wherein the first frequency level is approximately 150 to 200 nm and the second frequency level is approximately 200 to 280 nm.

54. A method as claimed in of claim 47, further including the step of controlling frequency of the ultraviolet radiation so as to target specific oxidisable pollutant material in the water.

55. A method as claimed in of claim 47 further including the step of subjecting water exiting the filter to ultraviolet radiation at approximately 254 nm so as to decompose the ozone so as to avoid increasing redox levels within the container to levels dangerous to the live aquatic organisms.

56. A filtration system for live aquatic organisms, the system including:
(i) a tank capable of supporting a flooded environment, the tank having a storage region for storing the organisms and distribution conduits through which fluid passes into the storage region and past the organisms; and
(ii) an assembly through which fluid from the tank is capable of being recycled and filtered;
wherein the assembly includes an ultraviolet source and an ozone supply for reducing a level of an oxidisable pollutant in the fluid by using ultraviolet radiation from the ultraviolet source in combination with presence of ozone from the ozone supply.
